(19) United States
(12) Patent Application Publication
(10) Pub. No.: US 2006/0032703 A1
(43) Pub. Date: Feb. 16, 2006

(54) Fall restraint device

(76) Inventor: William Burdet, Jericho, VT (US)

Correspondence Address: PRATT & WHITNEY, 400 MAIN STREET, MAIL STOP: 132-13, EAST HARTFORD, CT, 06108, US

(21) Appl. No.: 10/903,427

(22) Filed: Jul. 30, 2004

(51) Int. Cl. A62B 35/00

(52) U.S. Cl. 182/3

(57) ABSTRACT

An anchor assembly for preventing a user from falling from an object, comprising: a strap; a mechanism for retaining the strap on the object; and at least one anchor point on the strap to which the user can secure. A fall restraint device for preventing a user from falling from an object, comprising: an anchor assembly for tightening around the object and for keeping the strap tight around the object; a safety harness for securing to a user; and a lanyard securable to the anchor assembly and to the safety harness for preventing the user from falling from the object.

### BACKGROUND OF THE INVENTION

This invention relates to a fall restraint device. Specifically, the invention relates to a portable fall restraint device useable in a variety of situations.

The prevention of falls while working at height has received increased awareness of late. Falls from working at heights can cause serious injury or death, even from a relatively low height. These injuries obviously incur medical costs and can cause organizational disruption due to lost work.

While current fall prevention solutions exist, these devices have drawbacks. For example, one fall prevention solution is the use of metal-framed platform work stands. These work stands unfortunately have a limited work area. In addition, the stands can damage the object being worked on if improperly move. Finally, these work stands can be relatively expensive.

Another solution is the use of fixed anchor points on roof trusses within a building such as a hangar. The use of such fixed anchor points, however, requires placement of the object being worked on within the building. This may not prove adequate. Often, hangar space is at a premium and some work must be performed outside of the hangar, such as on the tarmac.

Another solution is an attachment point removably secured to the aircraft using a vacuum anchor system. The system includes suction cups that attach to the skin of the aircraft. Since the metallic skin of the aircraft is thin, these systems can damage the skin or paint on the skin. In addition, these systems are expensive and require continued maintenance. Facilities using such systems also need a negative pressure source to draw and to retain a vacuum between the suction cups and the metallic skin of the aircraft.

### BRIEF SUMMARY OF THE INVENTION

It is an object of the present invention to provide an improved fall restraint device.

It is a further object of the present invention to provide an inexpensive fall restraint device.

These and other objects of the present invention are achieved in one aspect by an anchor assembly for preventing a user from falling from an object. The assembly includes: a strap; a means for retaining the strap on the object; and at least one anchor point on the strap to which the user can secure.

These and other objects of the present invention are achieved in another aspect by a fall restraint device for preventing a user from falling from an object. The device includes: an anchor assembly for tightening around the object and for keeping the strap tight around the object; a safety harness for securing to a user; and a lanyard securable to the anchor assembly and to the safety harness for preventing the user from falling from the object.

These and other objects of the present invention are achieved in another aspect by a method of preventing a user from falling from an object. The method includes the steps of: securing an anchor assembly to the object; securing a safety harness to the user; and securing a lanyard to the strap and to the safety harness.

### BRIEF DESCRIPTION OF THE DRAWINGS

Other uses and advantages of the present invention will become apparent to those skilled in the art upon reference to the specification and the drawings, in which:

FIGS. 1A-C are elevational views of the various components of one embodiment of a fall restraint device of the present invention;

FIG. 2 is a perspective view of the component shown in FIG. 1C secured to a pylon of an aircraft;

FIG. 3 is an elevational view, in partial cut-away, of the fall restraint device of FIGS. 1A-C in use on an aircraft by a technician;

FIG. 4 is a perspective view of another component of one embodiment of a fall restraint device of the present invention;

FIG. 5A is a plan view of a pylon of an aircraft with the component of FIG. 4 secured thereto; and

FIG. 5B is a plan view of a pylon of an aircraft with the components of FIGS. 1C and 4 secured thereto.

### DETAILED DESCRIPTION OF THE INVENTION

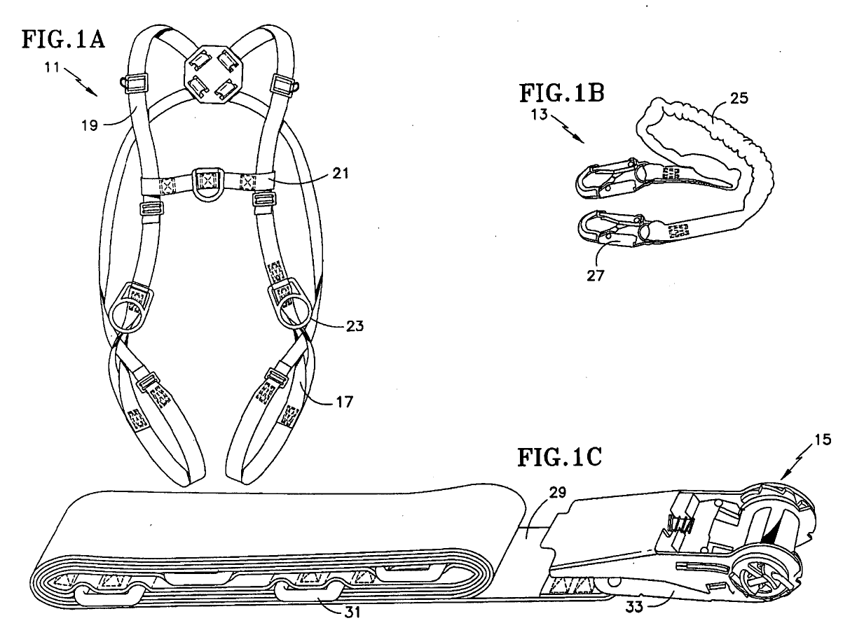

FIGS. 1A-C show various components of one embodiment of a fall restraint device of the present invention. The device is typically used on objects that do not have suitable points to which a technician can secure. The device includes a safety harness 11, a lanyard 13 and an anchor assembly 15. Each component will now be described in more detail.

The safety harness 11 could be any suitable body harness, such as Model Number 552/UYKU available from the Miller company of Franklin, Pa. The safety harness 11 could include leg straps 17, shoulder straps 19 and a chest strap 21. The safety harness could include one or more attachment points 23, such as D-rings, to which the lanyard 13 can secure. If needed, the safety harness 11 could have adjustable straps so as to fit different sized technicians.

The lanyard 13 could be any suitable lanyard, such as Model Number 1220007 available from DBI/SALA of Red Wing, Minn. The lanyard 13 could include a chord 25 with attachment points 27, such as snap hooks, to secure the lanyard 13 to the D-rings on the safety harness 11. Rather than being discrete as shown in the Figures, the lanyard 13 could be integral with the safety harness 11.

The anchor assembly 15 could include a strap 29 and one or more anchor points 31, such as safety rings, to which the lanyard 13 can secure. Although shown as D-rings, the safety rings could have any suitable shape such as round or square. The D-rings can secure to the strap 29 in any known manner, such as by stitching a loop in the strap 29 or by stitching a small section of webbing to the strap 29.

The strap 29 can be made from any suitable material, such as nylon webbing. In order to tighten the strap 29 around an object and to keep the strap 29 in such configuration (i.e. tension), the strap 29 could include a ratchet 33. Since ratchets 33 are commonly used on tie down straps, only a brief summary follows. After inserting the free end (not shown) of the strap 29 through the reel of the ratchet 33, the technician pulls the strap 29 taught. The technician then actuates the handle of the ratchet. Actuation of the handle rotates the reel, wrapping the strap 29 around the wheel and pulling the strap taught. The technician places the handle flat against the remainder of the ratchet 33 to lock the ratchet in this condition (i.e. the strap 29 in tension).

To release the strap 29, the technician actuates a release mechanism and rotates the handles away from the rest of the ratchet. This permits free rotation of the reel, allowing the unwinding of the strap 29 from the reel and the eventual removal of the strap 29 from around the object. The strap 29 and ratchet 33 could be any suitable ratchet strap-type tie down, such as an endless-type ratchet strap like model number 05512 available from Keeper Corporation of North Windham, Conn.

Although FIG. 1C shows a ratchet 33, the strap 29 could use any other suitable retention device. For example, the strap assembly 29 could use buckles, rings, cam buckles and/or patches of hook and loop fasteners secured to the strap 29 as the retention device to tighten the strap 29 around the object and to keep the strap 29 in such configuration.

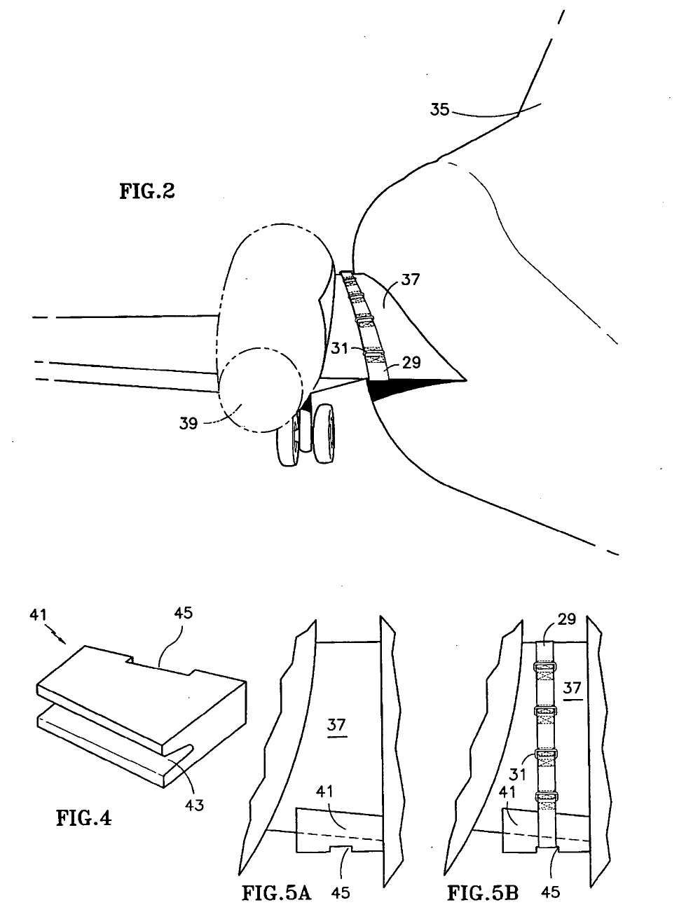

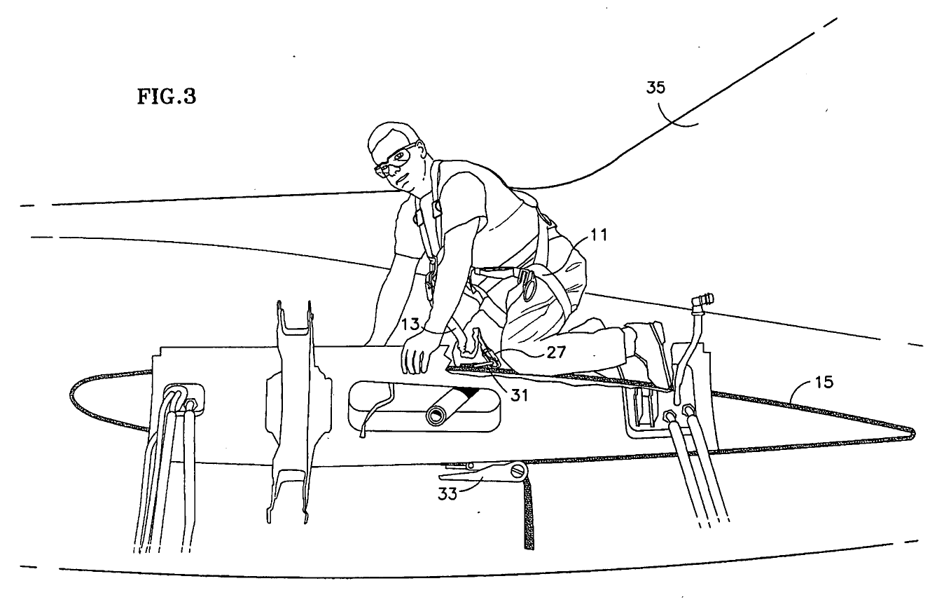

FIGS. 2 and 3 display the fall restraint device in use. FIG. 2 displays an object 35, namely an aircraft, which requires fall protection measures when a technician performs maintenance thereon. While the Figures show the fall restraint device used when the technician desires to perform maintenance on a pylon 37 extending from the fuselage, the fall restraint device could be mounted to any other suitable feature of the aircraft 35. Also, while FIG. 2 shows the pylon 37 supporting a gas turbine engine 39, the pylon 37 could also extend from the wing of the aircraft (e.g. for wing-mounted engines). If desired, the technician can place a mat (not shown) or other protective barrier between the aircraft and the anchor assembly 15, for example to prevent scratches on the aircraft surface.

The technician places the strap 29 along the pylon 37, and inserts the free end (not shown) of the strap 29 into the ratchet 33. The technician actuates the ratchet 33 (located on the underside of the pylon 37—see FIG. 3) to tighten the strap 29 around the pylon 37. Once suitably secured to the pylon 37, the anchor assembly 15 is ready for use.

The technician then dons the safety harness 11 and attaches the lanyard 13 to safety harness 11. Next, the technician mounts the pylon 37. The technician then secures the lanyard 13 to one of the anchor points 31 on the anchor assembly 15. FIG. 3 shows the technician tethered to the anchor assembly 15. The technician can now safely perform work on the pylon 37. If necessary, the technician can move to a different location on the pylon 37 by attaching the lanyard 13 to a different anchor point 31.

In instances where the pylon 37 has a tapered trailing edge, tightening of the strap 29 may cause the strap 29 to move from its original position (e.g. midspan of the pylon 37—see FIG. 2). FIG. 4 provides a block 41 to prevent such movement of the strap 29 while tightening. The block 41 is made from any suitable material, such as solid nylon or polytetrafluroethylene (PTFE). The block 41 has a first groove 43 along one face. The first groove corresponds to the shape of the tapered trailing edge of the pylon 37.

As seen in FIG. 5A, the first groove 43 accepts the tapered trailing edge of the pylon 37. The block 41 also has a second groove 45 along an opposite face. As seen in FIG. 5B, the second groove 45 accepts the strap 29. Even when tightened, the block 41 prevents movement of the strap 29 along the tapered trailing edge of the pylon 37. The block 41 also helps prevent damage to the tapered trailing edge of the pylon 37 due to over tightening of the strap 29.

The present invention has been described in connection with the preferred embodiments of the various figures. It is to be understood that other similar embodiments may be used or modifications and additions may be made to the described embodiment for performing the same function of the present invention without deviating therefrom. Therefore, the present invention should not be limited to any single embodiment, but rather construed in breadth and scope in accordance with the recitation of the appended claims.

1. An anchor assembly for preventing a user from falling from an object, comprising:
a strap;
means for retaining said strap on said object; and
at least one anchor point on said strap to which said user can secure.

2. The anchor assembly of claim 1, wherein said strap comprises webbing.

3. The anchor assembly of claim 1, wherein said means for retaining comprises a ratchet.

4. The anchor assembly of claim 1, wherein said anchor point comprises a safety ring.

5. The anchor assembly of claim 1, in combination with a lanyard securable to said anchor point.

6. The anchor assembly of claim 1, in combination with a safety harness securable to said anchor point.

7. The anchor assembly of claim 1, in combination with a block mountable to said object and engageable by said strap to prevent movement of said strap relative to said object.

8. A fall restraint device for preventing a user from falling from an object, comprising:
an anchor assembly for tightening around said object and for keeping said strap tight around said object;
a safety harness for securing to a user; and
a lanyard securable to said anchor assembly and to said safety harness for preventing said user from falling from said object.

9. The fall restraint device of claim 8, wherein said anchor assembly comprises:
a strap;
means for retaining said strap on said object; and
at least one anchor point on said strap to which said lanyard can secure.

10. The fall restraint device of claim 9, wherein said strap comprises webbing.

11. The fall restraint device of claim 9, wherein said means for retaining comprises a ratchet.

12. The fall restraint device of claim 9, wherein said anchor point comprises a safety ring.

13. The fall restraint device of claim 8, further comprising a block mountable to said object and engageable by said anchor assembly to prevent movement of said anchor assembly relative to said object.

14. The fall restraint device of claim 8, wherein said lanyard is discrete from said safety harness.

15. A method of preventing a user from falling from an object, comprising the steps of:
securing an anchor assembly to said object;
securing a safety harness to said user; and
securing a lanyard to said strap and to said safety harness.

16. The method of claim 15, wherein said anchor assembly comprises:
a strap;
means for retaining said strap on said object; and
at least one anchor point on said strap to which said lanyard can secure.

17. The method of claim 16, wherein said strap comprises webbing.

18. The method of claim 16, wherein means for retaining comprises a ratchet.

19. The method of claim 16, wherein said anchor point comprises a safety ring.

20. The method of claim 15, further comprising a step of mounting a block to said object, wherein said anchor assembly engages said block to prevent movement of said anchor assembly relative to said object.

21. The method of claim 15, wherein said object is an aircraft.

22. The method of claim 21, wherein said object is a pylon of an aircraft.
